(19) United States
(12) Patent Application Publication
(10) Pub. No.: US 2005/0210384 A1
(43) Pub. Date: Sep. 22, 2005

(54) MEMORY SYSTEM

(76) Inventors: James Brent Klassen, Langley (CA); Bryant Edward Diachuck, Langley (CA)

Correspondence Address: JAMES B. KLASSEN, 24382 70TH AVENUE, LANGLEY, BC, V1M 3K7, CA

(21) Appl. No.: 10/907,119

(22) Filed: Mar. 21, 2005

Related U.S. Application Data
(60) Provisional application No. 60/554,728, filed on Mar. 19, 2004.
(60) Provisional application No. 60/558,966, filed on Apr. 1, 2004.

(51) Int. Cl. G06F 17/27

(52) U.S. Cl. 715/534

(57) ABSTRACT

A memorization and accelerated learning system which greatly increases memorization and recall by organizing the text into steps, and causing words to disappear and reappear from step to step in a pattern which creates associations for every word in the text. The method and apparatus of the invention have equal applicability to words (combinations of characters) and individual characters. The method steps may be conveniently carried out over a wireless or wired network such as the internet.

### CROSS-REFERENCE TO RELATED APPLICATIONS

This application claims the benefit under 35 USC 119(e) of provisional patent applications 60/554,728 filed Mar. 19, 2004 and 60/558,966 filed Apr. 1, 2004.

### BACKGROUND OF THE INVENTION

Memorization of text is a difficult task for many people. Various methods are shown in the prior art to help people commit text to memory. These help-aids include using flash cards or word pictures or helpful hints to stimulate recall. Numerous computer programs also exist which track the users progress and automate more conventional memorization techniques such as repetition and the use of flash cards. Other prior art computer based programs remove words randomly so the user is not required to memorize the entire passage of text at one time, similar to erasing words from a phrase off a chalkboard.

### SUMMARY OF THE INVENTION

According to an aspect of the invention, there is provided a memorization and accelerated learning system which greatly increases memorization and recall by organizing the text into steps, and causing words to disappear and reappear from step to step in a pattern which creates associations for every word in the text. The method and apparatus of the invention have equal applicability to words (combinations of characters) and individual characters. The method steps may be conveniently carried out over a wireless or wired network such as the internet.

According to another aspect of the invention, the perceived effort of the user is reduced by insuring that only one additional word in sequence must be recalled by the user in each new step.

According to an aspect of the present invention, an association is created, in the mind of the user, any time a word is removed from the text while it is next to a word that is visible. This takes advantage of the brain's natural ability to store and access information based on information which is surrounding it.

When a missing word is preceded or followed by one visible word, it will be referred to in this disclosure as a “single association”. When a missing word is preceded by visible word and followed by a visible word, it will be referred to as a “double association”. The creation of single or double associations for every word in the text significantly enhances memorization and recall.

According to an aspect of the invention, a method of presenting text for memorization operates by a series of steps in which different versions of the text are presented. The steps correspond to presentation of a display that is modified from step to step. The presentation may be on a computer, printed text on a substrate or via sound. In another aspect of the invention, each step contains all of the words in the text or underlines where the words belong. The steps progress gradually from all of the text being visible in the first step, to all of the text being removed and replaced by underlines in the last step. If words were removed without reappearing again, as with a chalkboard system, it would only be possible to create associations for approximately 60% of the words in the text in most cases.

According to a further aspect of the invention, the majority of the words which are removed also reappear in subsequent steps in a pattern which insures that each word in the text receives an association at some point in the progression. To create associations for every word in the text in this way, the majority of the words in the text must become visible at least once after initially being removed.

According to an aspect of the invention, there is provided a text memorization or accelerated learning program such as for a computer display or printed text whereby words are removed in a progression of steps in which text is subject to modification such that all the text is visible in the first step; every fifth word is removed in the second step; every fourth word is removed in the third step; every third word is removed in the fourth step; every second word is removed in the fifth step; every second word is visible in the sixth step; every third word is visible in the seventh step; every third word is visible in the seventh step; every fourth word is visible in the eighth step; every fifth word is visible in the ninth step; and every word is removed in the tenth step. Variations of this aspect of the invention include sub-combinations of the method steps.

According to a further aspect of the invention, there is provided a memorization or accelerated learning program such as for a computer display or printed text whereby portions of text are removed in a progression of steps with the majority of the text being visible in a first step, and the majority of the text being removed in a last step, such that text becomes readable again after initially becoming non-readable.

According to other aspects of the invention: visible or readable portions of text are replaced by blank spaces or underlines or a non-readable graphic; visible or readable portions of text are replaced by dots or lines or dashes or some other character or graphic to indicate how many individual letters or numbers or characters are removed; only single words or numbers or characters in sequence are removed in the first or second steps; a maximum of two words or numbers or characters in sequence are removed in the first or second steps; only one additional word or number or character in sequence are removed in any step as compared to the maximum number of words or numbers or characters in sequence in the directly preceding step; and only two additional words or numbers or characters in sequence are removed in any step or level as compared to the maximum number of words or numbers or characters in sequence in the directly preceding level.

According to still further aspects of the invention, used for example with a computer, the user (subject) inputs missing text in order to progress to the subsequent step; the user is able to progress to subsequent levels without inputting missing words or letters or numbers or characters; the user is able to make individual words or numbers or characters appear, for example temporarily as for example for less than 1 or 2 seconds, with some method of input such as voice command, a screen tap or mouse click or key board stroke; an indication of the present step is visible; user input is used to select the number of steps displayed; the presentation is audible and gaps or silence in speech signifies removed words or characters; and the user may enter non-visible or non-readable or less-readable or less-audible or non-audible words by audibly speaking the words through a voice recognition program or other data entry method.

In other computer related aspects of the invention, the user may mouse-click or screen-tap or use some other method of input to make less readable text more readable or to make less audible text more audible; the computer program customizes a subsequent level or levels based on words or numbers or characters which the user made readable or more readable or audible or more audible in the previous level or stage; and a custom level has a word or number or character visible or readable before and/or after a removed problematic word or number as indicated by the user causing this word or character to become visible in a previous level.

In still further aspects of the invention, entire lines of text or portions of lines of text are made blank or non-visible or non-readable or less readable or non-readable or less-audible or non-audible; the method steps or apparatus may be applied to learning a sequence of characters such as numbers, a foreign language or how to spell.

In still further aspects of the invention, different types of words or numbers or characters are removed so that certain types of words or numbers or characters gain associations with other types of words or numbers or characters; subsequent stages give more attention to the type of words or numbers or characters a specific user has difficulty remembering; blocks of preceding and following text is readable or audible in a first stage to increase the contextual understanding of the text for the user; preceding and following text is readable or audible in subsequent stages; every word or number or character in the text receives an association; the majority of words or numbers or characters in the text receive an association.

Other aspects of the invention are found in the claims. Many methods of creating associations for all of the words in the text are contemplated by the inventor. Disclosed here are preferred embodiments that have been shown to be very simple and effective, along with a number of variations of these basic principles.

### BRIEF DESCRIPTION OF DRAWINGS

There will now be described preferred embodiments of the invention with reference to the drawings, and in which:

FIG. 1 is a diagram showing an example of the present invention as a ten step progression;

FIG. 2 is a diagram showing an example of the present invention showing the complete text chosen by the user and a first custom step focusing on the problematic words as indicated by the user in earlier non-custom steps;

FIG. 3 is a diagram showing an example of a second custom step focusing on the same problematic words from FIG. 2;

FIG. 4 is a diagram showing a second custom step focusing on the same problematic words from FIG. 2;

FIG. 5 is a diagram showing a third custom step focusing on the same problematic words from FIG. 2;

FIG. 6 is a diagram showing a preferred embodiment of the present invention for a flash card application;

FIG. 7 is a diagram showing an alternate embodiment of the present invention for a flash card application;

FIG. 8 is a diagram showing an example of the present invention as a six step progression;

FIG. 9 is a diagram showing an example of the present invention as a spelling tool;

FIG. 10 is a diagram showing an example of a more random embodiment of the present invention as applied to a random series of different characters such as for a password;

FIG. 11 is a diagram showing an example of a configuration of the present invention that can be used for already printed text;

FIG. 12 is a diagram showing another example of a configuration of the present invention that can be used for already printed text;

FIG. 13 is a diagram showing another example of a configuration of the present invention that can be used for already printed text;

FIG. 14 is a diagram showing a n example of a more advanced configuration of the present invention that can be used for already printed text; and

FIG. 15 is a diagram showing an example of an electronic configuration of the present invention that can be used for already printed text.

### DETAILED DESCRIPTION OF THE PRESENT INVENTION

The preferred embodiment of an exemplary embodiment of a method according to the invention progresses in steps. As the levels progress, words which are gradually removed in a pattern which causes the majority of the words which are removed to become visible again in a subsequent stage. In the preferred embodiment, the pattern of word removal from step to step is as follows: All the words are visible in step one, every fifth word is removed in step two, every fourth word is removed in step three, every third word is removed in step four, every second word is removed in step five, every second word is visible in step six, every third word is visible in step seven, every fourth word is visible in step eight, every fifth word is visible in step nine, and every word is removed in step ten.

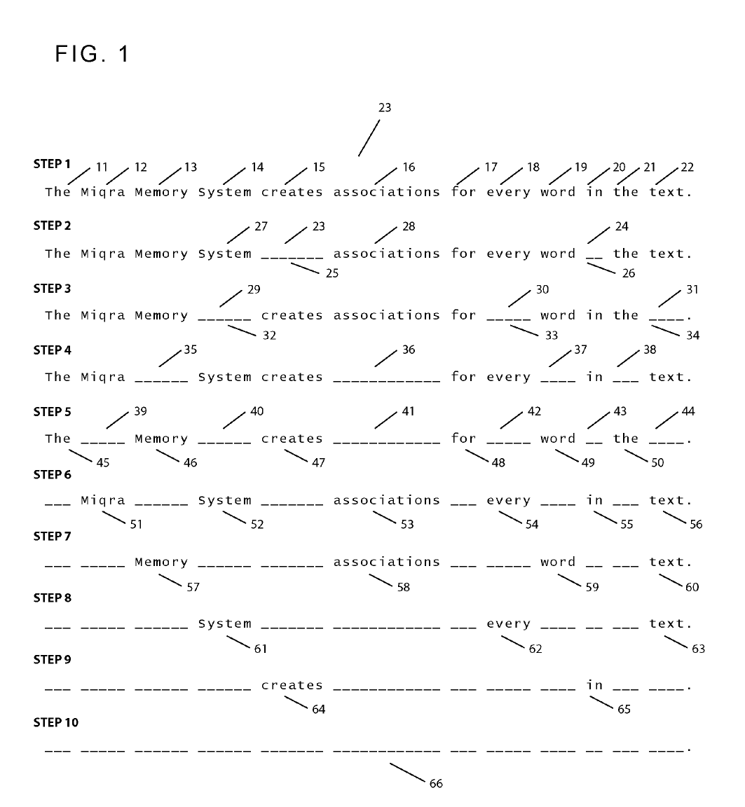

Referring now to FIG. 1, in step 1 all of the words 11 through 22 are visible so the user can read the text 23 and concentrate on its meaning without being preoccupied by trying to memorize the individual words.

In step 2, individual words in sequence 23, 24 are removed periodically from the text and replaced with underlines 25, 26 so the user needs only to recall these individual words 23, 24 instead of attempting to commit more than one word in sequence to memory.

It has been demonstrated that removing every fifth word in step 2 is a simple and effective way to gradually begin removing words. When the user recalls the removed words there is a double association created for each removed word in this example such as for the word 23 which is directly preceded by a visible word 27, and directly followed by a visible word 28.

In step 3, every fourth word 29, 30, 31 is removed and replaced by underlines 32, 33, 34. As a result of the specific pattern of removed words from step 2 to step 3, more words are removed from the phrase in step 3 as compared to step two, but both of the words 23, 24, that were removed in step 2 have become visible again. This allows the removed words 23, 24, from step 2 to be used to create associations for the removed words 29, 30, 31, in step 3. In step 3, the removed words 29, 30, are given a double association, while the last word in the phrase 31 is given a single association because it is preceded by the visible word 32 but it is not followed by any text.

In step 4, every third word 35, 36, 37, 38, is removed replaced with underlines. Note that although there are a total of four removed words 35, 36, 37, 38 in step 4, there is still only ever one removed word in sequence. This is the case, in the preferred embodiment, in steps 2 through 6, and is an important reason for the minimum effort for memorization required by users.

There are a number of different theories as to why this invention is so effective at reducing the time and effort required by many users to memorize and/or learn the meaning of text. One theory is that it allows the user to store information more directly to his or her long term memory by recalling information which has been recently stored in their short term memory. This is in contrast to a more conventional memorization method which requires the user to actively “memorize” the text using whatever methods or personal process they have become accustomed to. Removing only one word in sequence in steps 2 through 6, allows the user to recall words that have been visible in a recently previous level and which have therefore been recently stored in their short term memory as the user read these visible words.

In step 5 every second word 39, 40, 41, 42, 43, 44 is replaced by underlines and every first word 45, 46, 47, 48, 49, 50 is visible. Three of the words 35, 37, 38 which were removed in step 4 are visible again in step 5 and are used to create associations for the removed words 39, 40, 42, 43, 44.

In step 6 the pattern shifts from every second word being removed, as in step 5, to every second word 51, 52, 53, 54, 55, 56 being visible. In actuality, steps 5 and 6 are all that are needed to create associations for every word in the text. Condensed embodiments of the present invention with fewer steps will be disclosed herein as well, but for many people a ten step progression has proven to be the preferred embodiment.

In step 7, every third word 57, 58, 59, 60 is visible and the rest of the words are removed and replaced with underlines. In step 8 every fourth word 61, 62, 63 is visible and the rest of the words are removed and replaced with underlines, in step 9 every fifth word 64, 65 is visible and the rest of the words are removed and replaced with underlines, and in step 10 every word in the text is removed and replaced with underlines.

It has been shown that for many users, the gradual progression of this invention from all the words being visible in the first step to all the words being removed in the last step, along with the reappearing words which allow associations for all of the words in the text, allows them to read each step without the usual effort of memorization and in many cases to recite the last step 1 0 as if the words are still visible, and in effect, memorize the text without making the usual effort to memorize.

To use the present invention, the user may read each step as many times as needed to complete each step with no mistakes and no help, or they may proceed to each next step at a faster rate. It has been shown through experimentation that the accurate completion of each step is not necessary for the present invention to work successfully. In either case, minimal effort is required by the user because the perception is that they are simply “filling in the blanks” periodically rather than committing large bocks of text to memory all at once.

For printed applications, users are able to, and even encouraged to look back to previous levels every time they are not sure of a missing word, and they are encouraged to not do the work usually involved in trying to memorize because it has been shown that the easiest way for each individual user to complete each level is often the most effective technique for them personally.

For computer application of the present invention, the steps can progress screen by screen such as with the push of a button or key, or the steps can be scrolled up or down by the user so previous levels may be visible at the same time. It has been shown that users tend to intuitively remain at a particular level until they can complete it without error or to their personal satisfaction. Because of this, the present invention automatically allows the user to naturally control their progression at a rate which is best suited for them personally and for the text they are learning. By creating associations for every word in the text, and by creating a gradual progression of increasingly more words removed from step to step, the present invention has allowed many users to feel as though they are simply reading the text item rather than expending the anticipated effort to memorize. The effect is to reduce the often daunting task of memorization down to only having to recall, from their short term memory, as few one “associated” word or number or character in sequence at a time.

Importing Text

For a computer application the text can be imported into the present invention program from another program such as by choosing the text from a provided list or by cutting and pasting, or the text can be highlighted and the present invention program launched for that text with an input such as a right mouse button menu option or screen tap menu.

For memorizing text, it is often important to understand the context of the passage. For this reason it may be beneficial for the program to automatically include the preceding and following blocks of text into the first level, or possibly into subsequent levels as well, this creates a kind of macro-association of the overall meaning of the text with the overall meaning of the text preceding and/or following the chosen text. If text before and after is visible, then double associations are possible for first and last words in the chosen text as well.

Recall Function for Computer Use

Another advantage of a computer or PDA application is the ability to use a keyboard input, mouse click, screen tap or other user input to control the progression through the steps and/or to cause words to reappear as a help function. If the user is struggling with a particular stage, they have the option to move back to a previous stage, or to indicate the problematic missing words such as with a keyboard input or mouse click or screen tap in the vicinity of the problematic missing word to have these individual words appear momentarily in that stage, or to use some sort of input such as a “recall” mouse click or screen tap button or hot-key to have all the removed words in the text appear momentarily. A single “recall” input such as a button or hot-key may be preferred by desktop or laptop computer users as it does not require them to follow their reading with the cursor.

Test Level and Custom Levels

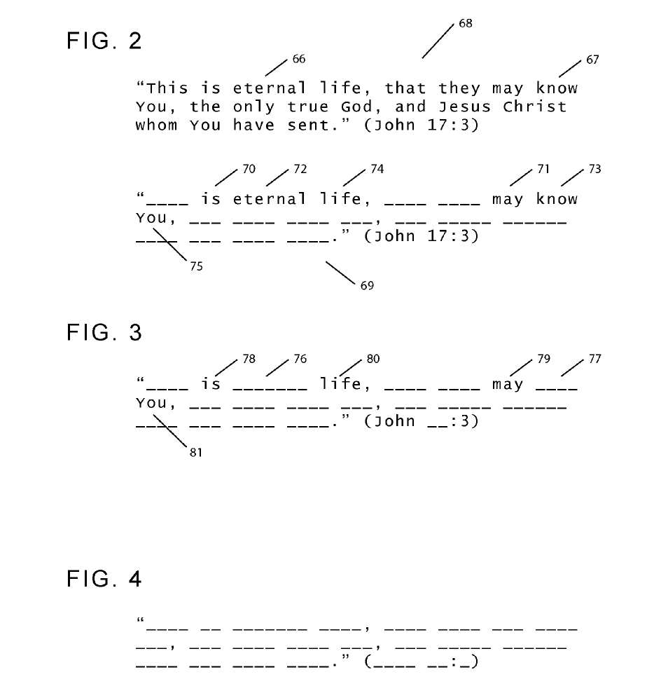

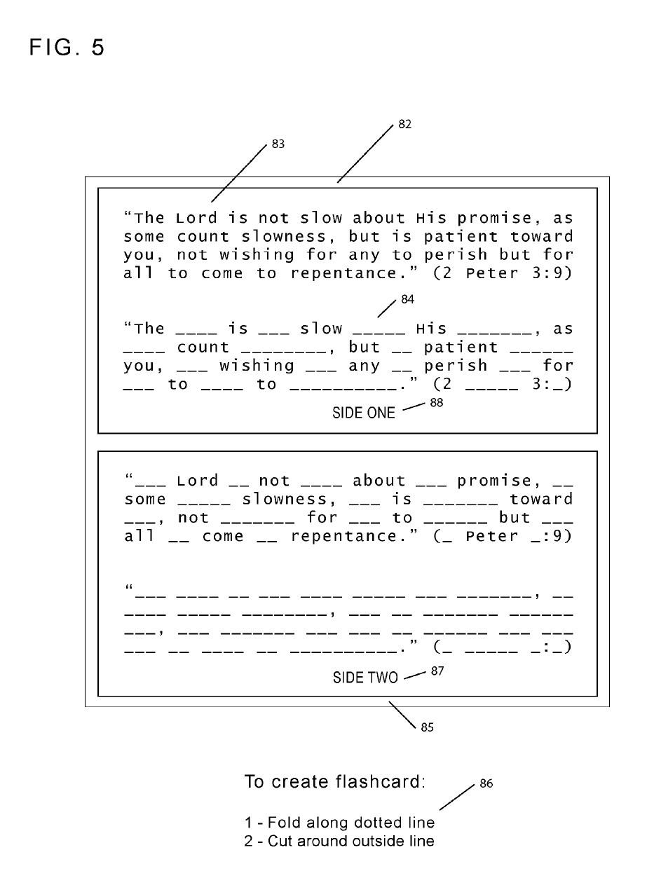

With the option to make individual words visible it is possible for an embodiment of the present invention as a computer program to generate custom subsequent stages which will be more specific to the individual user's problematic words. A custom subsequent level may take many forms but in the preferred embodiment insures that a problematic word from the non-custom steps is removed in one or more of the custom steps when it directly preceded or directly succeeded a visible association word. FIGS. 2 through 4 show an example of three custom generated steps which focus on the problematic words that the user, in this example, had to make visible one or more times during the initial non-custom steps. In this case, the user demonstrated that he or she had difficulty with the word 66 and the word 67 shown in step 1 of the complete text 68 (steps 2 through 10 are not shown here). The first custom step 69 consists of all spaces except for the words 70, 71 directly preceding the problematic words 72, 73 the problematic words themselves 72, 73 and the words 74, 75 directly following the problematic words 72, 73. In the second custom stage in FIG. 3, the problematic words 76, 77 are removed so an association can be reinforced with the preceding words 78, 79 and the following words 80, 81. In FIG. 4 all of the words are removed, and any user inputs can again be used to create additional custom steps. This format may also be useful when combined with a test step with all the words removed to establish by some method such as by user screen taps, which words are problematic. A test step with this function could also be used as the first step of a review function, and in this way provide a very efficiently way to determine what words need to be focused on, and therefore reduce the time and effort required by the user to insure that previously memorized text is stored accurately in their long term memory.

Some PDA users may also prefer to use the hot-key function to make all missing words visible momentarily as it only requires the user to follow the text with their eyes and makes the program operable with one hand.

The “recall” button or hot-key function of a computer embodiment of the present invention allows the words to appear only momentarily, preferably for approximately 0.8 seconds, but longer or shorter times may be used as well. This way, the user is prevented from holding the “recall” button or hot-key down to read the whole passage. A delay of a fraction of a second, preferably 0.5 seconds, but longer or shorter times may also be used, is also preferably programmed into the hot key or screen-tap help functions to prevent the user from rapidly using the “recall” function to cause the words to appear nearly constantly.

The “recall” button function has been shown to be highly effective in providing help for problematic words and even seems to help many users commit these words to memory. It was assumed during initial testing of this invention that the user would need to repeat each step until he or she no longer needed to use the recall button on each individual stage, but through testing it has become apparent that attempting to recall a difficult word and then having that word become visible shortly thereafter, as a result of the user activating the “recall” function, has the effect of committing that word to memory in such a way that some users have found that they can read through each step only once, using the recall function as often as they need to, and still be able to recite the last step without error.

For accelerated learning applications, where it is necessary to learn the meaning of the text without actually memorizing it, the periodically missing words have the effect of engaging the user in what they are reading so words cannot be skimmed over as with just reading the text.

Certain memorization systems in the prior art require the user to manually input missing text in order to complete a particular level or stage or step. With the various embodiments of the present invention, the user may input words verbally and/or manually, but it is the opinion of the inventor that for many applications the present invention is so effective that manually inputting removed text is more time consuming than it is worth, and that it is significantly more effective and significantly less effort for the user to simply recite the words to themselves, or out loud, and to progress to the next level when they are confident to do so.

Requiring the user to manually input removed text might seem like an effective way to prevent the user from progressing to the next level without completing the present level, but the inventor believes that a significantly more effective strategy with the present invention, is to make the system as little work as possible for the user as per the above description.

For the computer program embodiment of the present invention, it is preferable to have an automatic review function which helps the user schedule the frequency and/or number of times to review a memorized text item. This function preferably gives the user the choice to schedule a short and/or a long term review. The short term review option preferably schedules reviews with a decreasing time increment so the text comes up for review progressively more frequently toward a specific or general date chosen by the user. The long term review option preferably schedules reviews on an increasing time increment so the text comes up for review progressively less frequently for a length of time such as a number of hours, days, weeks, months, years, or for life as chosen by the user. It is believed by the inventor that any type of review schedule should include a first review a maximum of twelve hours after first memorizing a text item. The automatic review schedule function would alert the user whenever a text item is due for review and would also list the items that will be due for review in the near future.

For the computer program embodiment of the present invention, it is also preferable to have a data base for the user's text which has been, or will be memorized. This data base can be used to store text items along with statistics about each text item which can be readily referenced by the user. Statistics may include information such as, but not limited to, when the text was first memorized; how many times the text has been reviewed; when the last review was done; and when the next review is due.

Other Numbers of Steps

It is possible to create associations for every word in the text with as few as two steps by using step 5 and step 6 from FIG. 1, but it is believed by the inventor that at least 4 steps is preferred in a condensed embodiment in order to store the text in one's short term memory by reading the complete text in a first level, and to provide a final level where all the words are removed so the user and/or the computer program can determine if there are any problematic words.

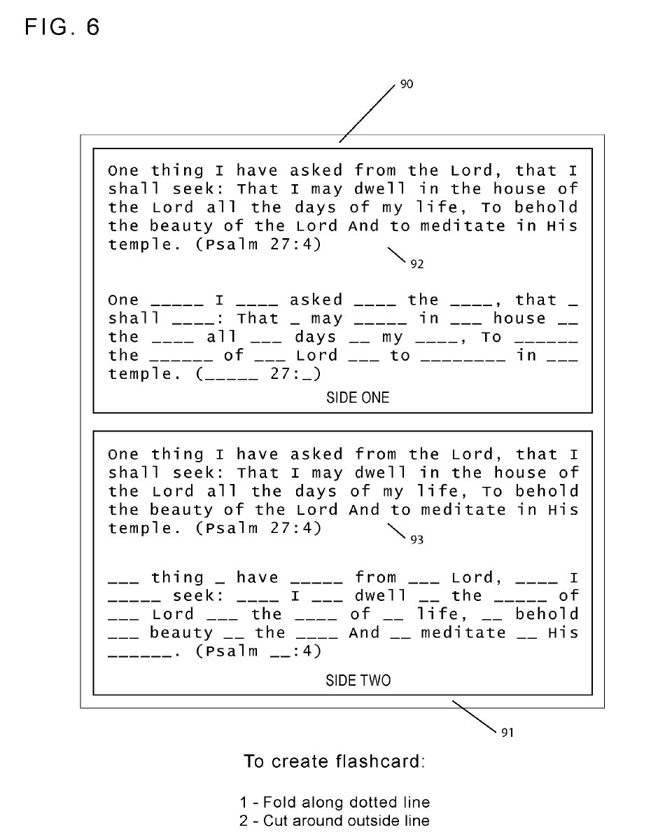

An embodiment such as for, but not limited to, flashcards, with the above mentioned series of steps is shown in FIGS. 5 and 6. FIG. 5 shows the front of the preferred flashcard embodiment 82 with the first step 83 and the fifth step 84 from FIG. 1 such as for if the card is to be printed. The back 85 of the preferred flashcard embodiment consists of the sixth and seventh steps from FIG. 1. In the example in FIG. 5, the card is designed to be printed on a single piece of paper and then folded over and cut out as per the example of the directions 86 which are preferably printed automatically with the card. A printed indication of side one 88 and side two 89 are preferably provided. Flashcards using two or more steps of the present invention can also be integrated into a computer display.

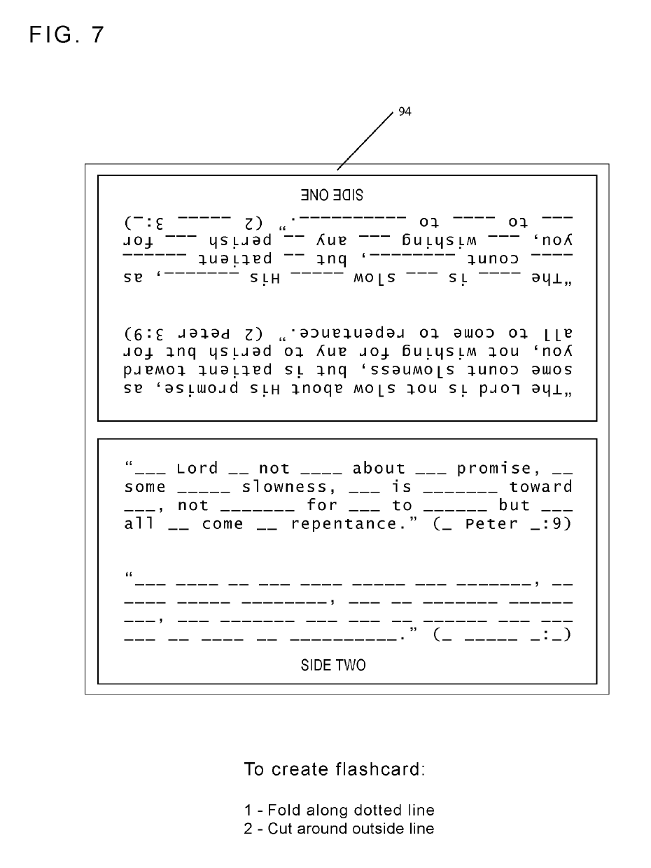

An alternate embodiment such as for, but not limited to, flashcards is shown in FIG. 6 which does not progress from the majority of the words being visible to the majority of the words being removed, but where the majority of the words which are removed on side one 90 are visible again on side two 91. The benefit of this embodiment is that it provides the complete text from the first step in FIG. 1 on both sides of the flashcard 90, 91 so the user can quickly refer to this complete text 92, 93 for help without flipping the card over. A flashcard could also have more than two steps with missing words, possibly with a smaller font size. Printing one of the sides 94 upside-down as shown in FIG. 7 would allow both sides to be right side up when one side is folded over, this may be a preferred embodiment for some flashcard applications and/or for some users.

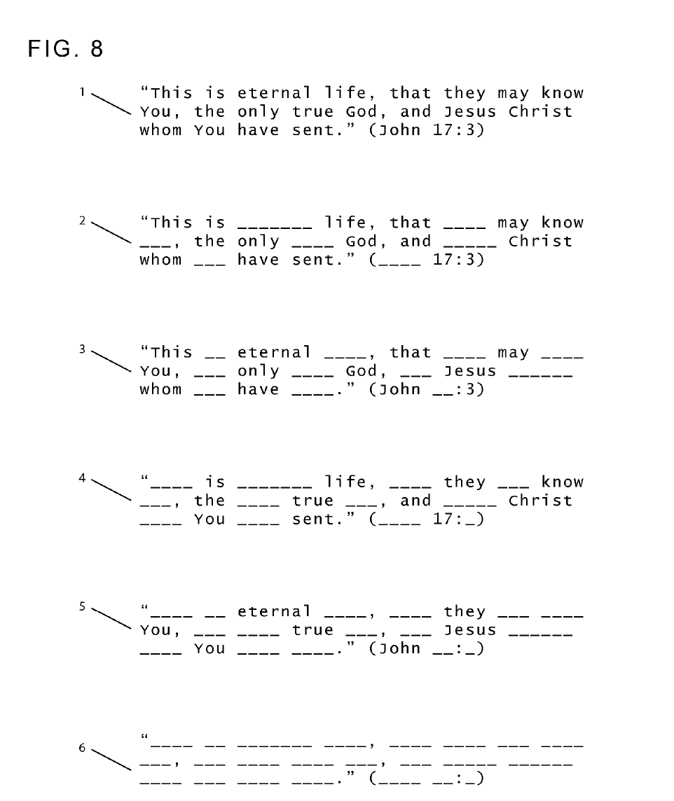

An example of a condensed embodiment of the present invention with six steps is shown in FIG. 8. This type of embodiment, with fewer than ten steps, is preferably given as an option in computer or printed applications for users who are more skilled at memorizing, or for review purposes where all ten steps would take more time and effort than necessary, or for longer blocks of text which would take too long to read through ten times. If fewer than ten steps is chosen, it is preferred that the steps start and end with steps 1 and 10 from FIG. 1 and that the steps 5 and 6 from FIG. 1 are used in the progression. Many different numbers and combinations of steps are anticipated by the inventor. The preferred progression of steps for eight steps total is steps 1, 3, 4, 5, 6, 7, 8, 10 from FIG. 1. An example of the preferred progression of steps for six steps total is shown in FIG. 8 with steps 1, 4, 5, 6, 7, 10 from FIG. 1. The preferred progression of steps for four steps total is steps 1, 5, 6, 10 from FIG. 1. The preferred progression of steps for two steps total is steps 5 and step 6 from FIG. 1.

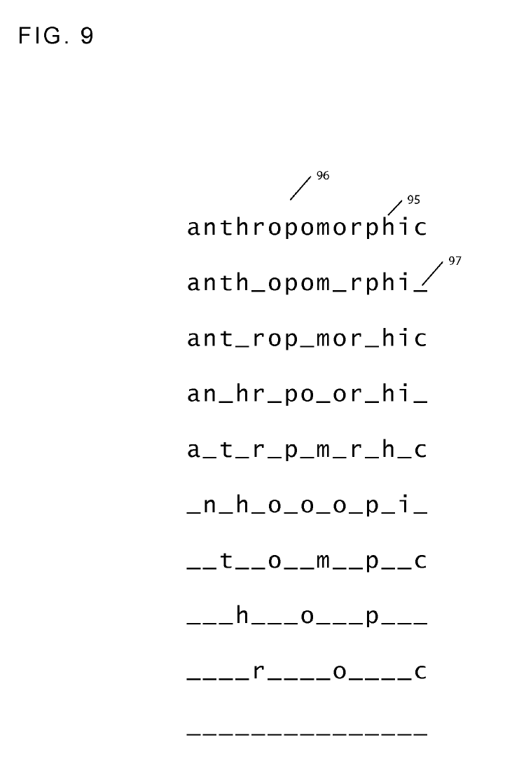

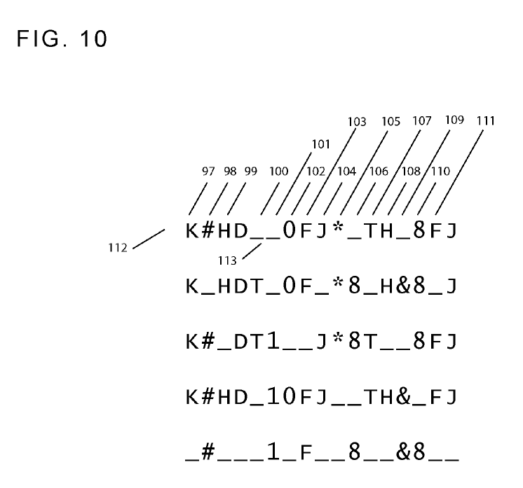

FIG. 9 shows an example of the present invention as a spelling aid. In this example the individual letters 95 of the word 96 are removed and reappear in a pattern similar to how words are removed in steps 1 through 10 in FIG. 1. A preferred application of the spelling tool requires the user to fill in the blanks 97 with a pen or pencil or to manually enter each letter with a keyboard or stylus or other data entry method if it is a computer application. For certain spelling applications, such as for teaching children to spell, it is also preferable to include a sentence, which is visible initially, which uses the word 94 in a sentence so the user understands the meaning of the word.

When the present invention is used to memorize or learn a phrase of text, it is preferred but not required to leave all punctuation visible in all steps. When the present invention is used as a spelling tool, it is preferable to leave non-letter characters such as, but not limited to, hyphens and apostrophes visible in all steps.

It is important for the number of words on each line to remain the same as the levels progress. This gives the user a consistent visual framework as they progress through the steps. This may be accomplished by a custom font which replaces each missing letter or character or number with a dash or dot or underline having a width which is the same or similar to each missing letter. In this way, the length of each missing word will remain the same and the program simply has to change the font of each word or portion of text which is to be removed in each level.

It has been found by testing, however, that a more effective solution, is to use a mono-type font such as Lucida Console which has a consistent width for each character. This tends to reduce the amount of visual information the user must process as he or she determines the length of the removed word based on the number of spaces.

It is also believed by the inventor to be advantageous to include a visible indication, such as a number and/or a series of graphic bars that appear or light up or change color, for the user to see what step they are on. This helps the user by providing a visual reference, and may also help to motivate the user to progress to the next step, and/or to give the user a specified goal.

Audio

A further embodiment of the present invention uses an audible interface to audibly “read” printed words to the user with progressively omitted or less audible or less distinguishable words. Such a system keeps track of user accuracy by the use of voice recognition software or lets the user follow along visually and allows the user to simply recite the words out loud or to themselves. With a voice recognition embodiment, the computer could determine when the user is ready to progress to the next level, but it is believed by the inventor that for many applications it is preferable for the user to choose to advance to the next level when they are confident enough to progress.

Other Variations with Majority of Words Given Associations

Other embodiments of the present invention are also contemplated that allow for a less consistent spacing of visible and/or removed words or letters or characters, as long as the majority of the individual words or letters or characters in the chosen passage of text are removed in at least one of the steps which directly preceded and/or followed by a visible word, letter or character. In this way, the invention allows the development of other patterns and algorithms that create associations between readable and non-readable words, letters, or characters for the majority of the chosen text. This can be done in a progression or rotation, or succession of two or more steps or stages or levels which progress in a manner which creates an association for a majority of the words or letters or characters in at least one step, stage, or level.

The present invention achieves this requirement of creating associations for the majority of words or numbers or characters in the text by causing the majority of words or numbers or characters which are removed, to reappear at least once in at least one step after initially being removed.

Other embodiments of the present invention are also contemplated which allow for a less structured progression from step to step as long as the number of removed words or letters or characters in sequence, in the first step with removed words, is not more than two words in sequence. This ensures that an association is created for each of these removed words or letters or characters.

Other embodiments of the present invention are also anticipated which allow for a less structured, but still gradual, progression from step to step by removing a maximum of one additional word or number or character in sequence as compared to the maximum number of removed words or numbers or characters in sequence in the directly preceding level. Although not preferable, there is significant benefit which can be realized by the removal of a maximum of two additional words or numbers or characters in sequence as compared to the maximum number of words or numbers or characters in sequence the directly preceding level.

Other embodiments of the present invention are also contemplated which allow for every word in the text to receive an association by insuring that every word in the text is visible in at least one step while being directly preceded and/or directly succeeded by a visible word. Although not preferable, there is significant benefit which can be realized by insuring that the majority of the words in the text receive an association by insuring that the majority of the words in the text are visible in at least one step while being directly preceded and/or directly succeeded by a visible word.

FIG. 10 is an example of letters and numbers and characters (referred to here generally as “characters”) which are removed randomly with variations within the broadest scope of this invention. In this example, the majority of the characters 97, 98, 99, 100, 101, 102, 103, 104, 105, 106, 107, 108, 109, 110, 111 receive an association, by being removed while next to a visible word, in at least one step, and the maximum number of removed characters in sequence in the first step 112 with removed characters is two characters 113, and the majority of the characters 98, 99, 100, 101, 102, 103, 104, 106, 107, 108, 109, 110, 111 which are removed become visible again after being removed the first time. This example uses individual characters, but the same principles could be applied to words or other types of text. FIG. 10 is not a limiting example of the claims of this disclosure.

Types of Words

In another embodiment of the present invention, different types of words or numbers or characters such as, but not limited to nouns, pronouns, adjectives, verbs, and adverbs or their equivalents in other languages or other types of documents, are removed in accordance with the basic principles of the present invention such as, but not limited to, making every noun or every second noun or every third noun less visible or non-visible in an earlier step. In a subsequent step all or a number of a different type of words may be removed and all or a number of the previously removed words may become visible again. In this way, or in numerous other variations, associations can be created for the user between different types of words, numbers, or characters.

Variations

It is anticipated in this disclosure that different numbers of steps or levels or stages are possible. The examples in this disclosure have been used because they are considered, by the inventor, to be well suited to describe and demonstrate the basic concepts of the present invention.

It should also be noted that all of the embodiments in this patent can be used for numerous other applications such as for technical documents or with languages that are read vertically or in other directions or manners as compared to the English language, or with languages or documents which use symbols instead of words or letters or numbers.

Numerous other methods of making the printed or displayed text less visible or less readable by changing color or brightness or blurring or shading or flickering or by changing font style or size or color are all anticipated by the inventor. Also, underlines are preferable with spaces between each underline to indicate how many letters or characters each missing word is comprised of, but underlines without spaces between them, or dots or dashes or shapes or colored boxes or any type of indication as to the length of the missing word or the number of missing letters are all anticipated by the inventor.

Various help aids such as visible portions of words or visible individual letters may be used to give the user additional recall assistance, but the inventor's belief is that this may not be necessary for many users except possibly in a test or review level.

It is also believed by the inventor that this invention may have application as a low effort level exercise or rehabilitation program for developing and/or restoring certain brain functions because the meaning of the text tends to be stored, for some users, before the words are committed to long term memory. This may be especially useful for mentally challenged individuals or for assisting in the recovery of injured people such as head trauma patients or stroke victims.

Obscuring of Printed Text.

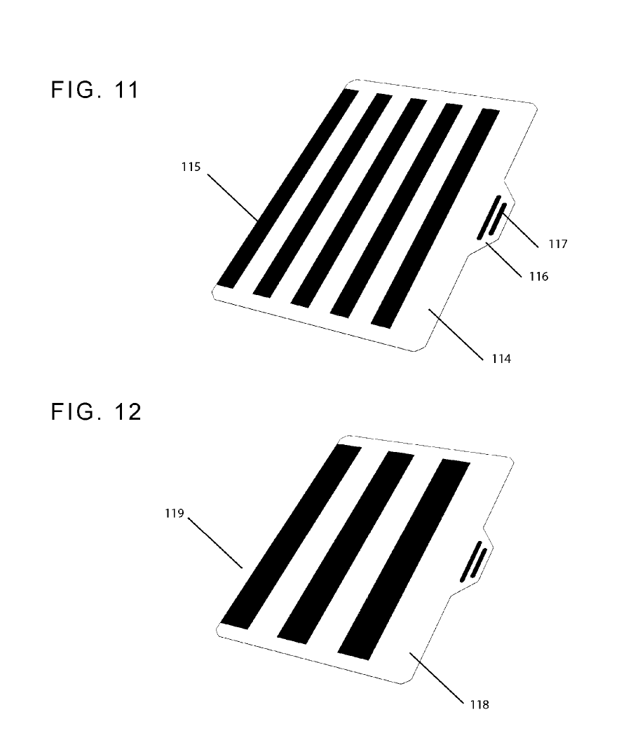

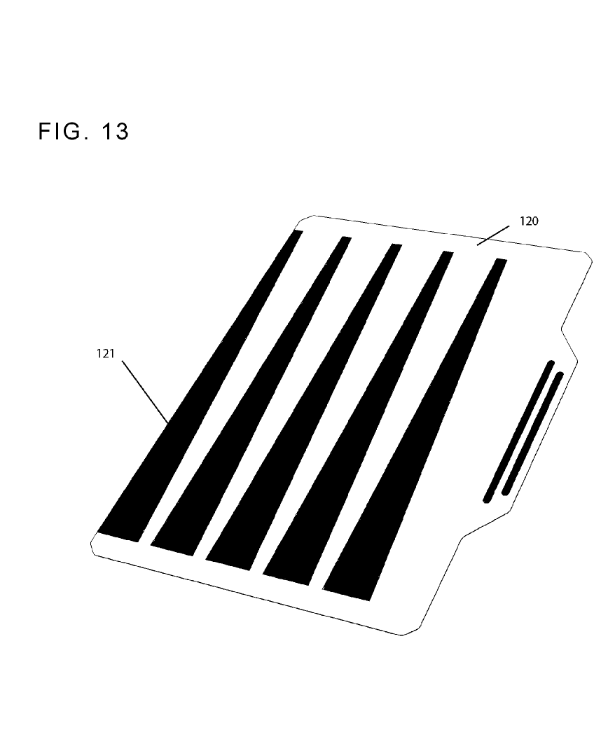

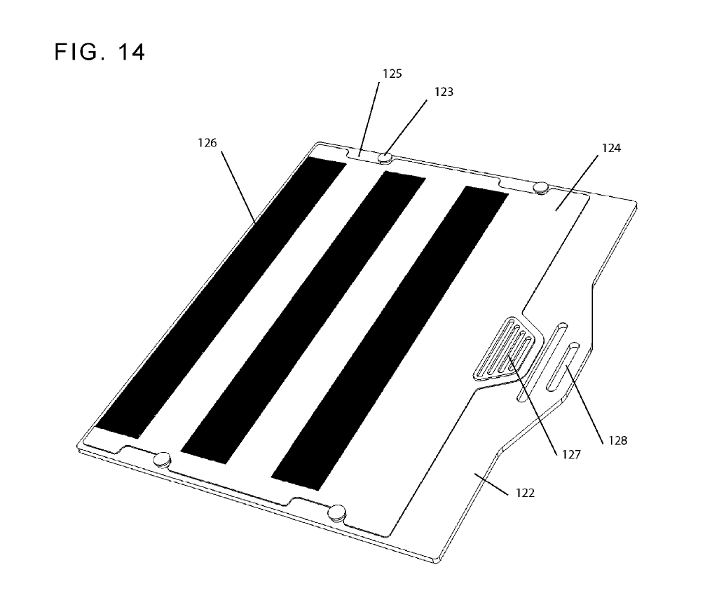

Many of the benefits of this invention may also be realized for use with text that has already been printed, such as, but not limited to a university text book, by covering up or obscuring portions of text with a mask such as a plastic transparencies with horizontal or vertical non-transparent or opaque stripes or areas. Various widths and spacing of stripes may be chosen by the user, and the transparencies may be moved horizontally and/or vertically by the user to cause initially obscured text to become visible again. FIG. 11 shows an example transparency sheet 114 with vertical stripes 115 and a grip area 116 with tactile strips 117 for ease of placement and movement of the sheet 115 buy the user. FIG. 12 shows similar example of a transparency sheet 118 with wider stripes 119 which may be used for different types of text, or as a step in the progression chosen by the user. FIG. 13 shows an example of an embodiment of a transparent sheet 120 with tapered vertical stripes 121 which can be moved vertically by the user to gradually obscure more text. The stripes 121 may also be positioned horizontally for different effects or for languages which are read vertically. FIG. 14 is an example of a transparent holder 122 with stops 123 which is used to more accurately and consistently position a transparent sheet 124 which has slots 125 which contact the stops 123 to allow the user to easily position the stripes 126 to the left or right so text that is initially obscured becomes visible again. The transparency sheet 124 has a thumb grip area 127 and the holder 122 has a finger grip area 128. Different transparency sheets may be used with different widths of stripes and corresponding lengths of slots 125 to ensure that the movement of the sheet 124 causes all of the text which is obscured in the left position will become visible when the sheet 124 is moved to the right position. This embodiment may also be configured to move vertically with horizontal stripes such as for use with vertically read languages.

An opaque or non-transparent paper or plastic sheet with material removed so text can be viewed through these opening is also contemplated by the inventor.

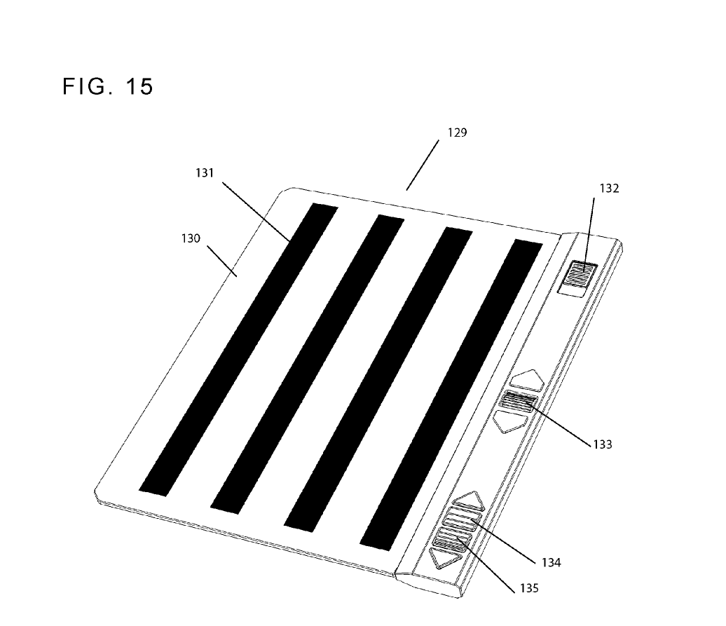

FIG. 15 shows an electronic device or mask 129 which uses a transparent glass or plastic sheet 130 with some sort of electronic darkening or opaquing characteristic such as, but not limited to an LED or LCD display 131 which obscures portions of text. The device 129 may be placed over the text and adjusted by the user. Many different configurations are conceivable. In this example, the button 132 is used to switch between vertical and horizontal stripes. The thumbwheel 133 is used to adjust the width of the stripes or some other adjustment, and the button 134 and the button 135 are used to advance or move backward through a series of steps of various sizes and shapes of opaque stripes or areas as defined by a pre-programmed algorithm.

These type of systems need not necessarily cover up individual words, but approximately block out certain areas of text. An advanced embodiment of the electronic text obscuring device may recognize individual words and obscure individual words. Benefit may be realized by users who are desire to memorize already printed text, or just to learn the meaning of text more quickly.

Printed Versions with Obscured Text which can be Made Visible

Many of the benefits of this invention may also be realized for use with text that has already been printed, such as, but not limited to children's books by using means such as a paper or plastic or cloth flap or sliding device to cover up certain words and/or to make certain words visible that are initially covered up or to make visible words visible again after they where covered up a first time.

General Applications

The present invention has been shown to provide tremendous benefit in printed form as well as for use in computer and Personal Digital Assistant format. The system may be delivered to a user through the internet, by the user attending a website using a web browser, and following instructions according to the principles outlined here, and instructions for carrying out the methods may be stored on any suitable computer readable media.

Applications for this invention include memorizing and accelerated learning of various types of text including phrases, spelling, numbers and other characters in English and other languages. The present invention has been shown to be so effective in reducing the time and work required to commit text to memory, that many people who use it are able to store and recall information without the usual effort or dread that is often associated with trying to memorize.

Definitions of Terms

“Word” or “words” in this disclosure includes numbers, characters, or words in any language. “Steps” in this disclosure includes levels or stages or any other type of progression. “Visible” in this disclosure includes any word or number or character that is legible enough to be easily read.- “Removed” or “removed for comprehension” in this disclosure includes the use of blank spaces, underlines or dots or some sort of graphic to replace or modify individual words or individual letters or numbers or characters or to make words or numbers or letters or characters non-readable in some way. In the case of an audible presentation of text, removed from comprehension means made non-audible by for example silence or replacement by another sound. “Visible words in sequence” refers to any number of readable words in a row which are not interrupted by any non-readable words. “Removed words in sequence” refers to any number of removed words in a row which are not interrupted by any readable words. “Majority” means more than half. “Subsequent” or “following” mean after a later or subsequent level or word or number or character but not necessarily directly after. “Preceding” means before a later or subsequent level or word or number or character but not necessarily directly before. “Input” from a user or subject using a computer includes any input such as voice command, sensed thought, screen tap, mouse click or hot key/s.

“Scripture quotations taken from the New American Standard Bible®, Copyright© 1960, 1962, 1963, 1968, 1971, 1972, 1973, 1975, 1977, 1995 by The Lockman Foundation Used by permission.”

Immaterial modifications from the embodiments described come within the scope of the invention.

The following statements describe certain aspects of the invention:

Statement one: A method of presenting text to a subject, the method comprising the steps of: presenting text in human comprehensible format, where the text includes characters; and in a succession of steps, presenting a series of modifications of the text in human comprehensible format, the series of modifications incorporating at least a first modification of the text in which characters are removed from comprehension in a non-random pattern and at least one subsequent modification in which removed characters re-appear for comprehension.

Statement two: The method of statement one in which the characters are removed and re-appear in groups forming words, and the text is presented visually.

Statement three: The method of statement two in which the pattern comprises removal of every nth word counting from a specific word in the text.

Statement four: The method of statement three in which, in a second modification succeeding the first modification, every (n−1)th word is removed.

Statement five: The method of statement two in which the presentation occurs over the internet, and removing words is carried out by deletion of words, obscuring of words or replacement of words by blanks or other marks.

Statement six.: The method of statement two in which removed words are replaced by a mark indicating the number of characters in the word.

Statement seven: The method of statement two in which words removed from the first modification are spaced by at least one word that is not removed.

Statement eight: The method of statement two in which words removed from the next successive modification to the first modification are spaced by at least one word that is not removed.

Statement nine: The method of statement two in which words present in the first modification are spaced by not more than two words that are removed.

Statement ten. The method of statement two in which words present in the next successive modification to the first modification are spaced by not more than two words that are removed.

Statement eleven: The method of statement two in which, where n words in a sequence are removed in a specific modification, no more than n+1 words are removed in the next succeeding modification.

Statement twelve: The method of statement two in which, where n words in a sequence are removed in a specific modification, no more than n+2 words are removed in the next succeeding modification.

Statement thirteen: The method of statement one where the text is presented audibly.

Statement fourteen: A method of presenting text to a subject, the method comprising the steps of: presenting text in human comprehensible format, where the text includes words; in a succession of steps, presenting a series of modifications of the text in human comprehensible format, the series of modifications incorporating at least a first modification of the text in which words are removed from comprehension in a pattern and at least one subsequent modification in which removed words re-appear for comprehension; and the series of modifications includes a specific modification in which every second word is removed to yield a set of alternating removed words and remaining words and a subsequent modification to the specific modification in which the removed words are made comprehensible again and the remaining words are removed from comprehension.

Statement fifteen: The method of statement fourteen in which the text is presented visually.

Statement sixteen: A method of presenting text to a subject, the method comprising the steps of: presenting text in human comprehensible format, where the text includes words; in a succession of steps, presenting a series of modifications of the text in human comprehensible format, the series of modifications incorporating at least a first modification of the text in which words are removed from comprehension and at least one subsequent modification in which removed words re-appear for comprehension; and

interspersing presentation of all of the text with the series of modifications.

Statement seventeen: The method of statement sixteen in which order of presentation of the modifications of the text is user selected.

Statement eighteen: A method of presenting text to a subject, the method comprising the steps of: presenting text in human comprehensible format, where the text includes words; in a succession of steps, presenting a series of modifications of the text in human comprehensible format, the series of modifications incorporating at least a first modification of the text in which words are removed from comprehension in a pattern and at least one subsequent modification in which removed words re-appear for comprehension; the series of modifications including: a modification of the text in which each fifth word, counting from a specific word, is removed; a modification of the text in which each fourth word, counting from the specific word, is removed; a modification of the text in which each third word, counting from the specific word, is removed; and a modification of the text in which each second word, counting from the specific word, is removed.

Statement nineteen: The method of statement eighteen in which the specific word is the first word in the text.

Statement twenty: The method of statement nineteen in which the specific word is the last word in the text.

Statement twenty one: The method of statement eighteen in which the series of modifications is presented in the order specified in the claim.

Statement twenty two: The method of statement eighteen in which the modifications in the series of modifications are presented sequentially, without intervening presentations.

Statement twenty three: The method of statement eighteen in which the series of modifications further includes: a modification of the text in which only each second word, counting from the specific word, is present; a modification of the text in which only each third word, counting from the specific word, is present; a modification of the text in which only each fourth word, counting from the specific word, is present; and a modification of the text in which only each fifth word, counting from the specific word, is present.

Statement twenty four: The method of statement eighteen in which the text is presented visually.

Statement twenty five: A method of presenting text to a subject, the method comprising the steps of: presenting text in human comprehensible format, where the text includes characters; and in a succession of steps, resenting a series of modifications of the text in human comprehensible format, the series of modifications incorporating at least a first modification of the text in which characters are removed from comprehension and at least one subsequent modification in which removed characters re-appear for comprehension; and the series of modifications of the text providing an association for a majority of the characters in the text.

Statement twenty six: The method of statement twenty five in which the characters are removed and re-appear in groups forming words.

Statement twenty seven: The method of statement twenty five in which the series of modifications of the text provides an association for more than 75% of the words in the text.

Statement twenty eight: The method of statement twenty five in which the series of modifications of the text provides an association for all of the words in the text

Statement twenty nine: A method of presenting text to a subject, the method comprising the steps of: presenting text in human comprehensible format, where the text includes characters; in a succession of steps, presenting a series of modifications of the text in human comprehensible format, the series of modifications incorporating at least a first modification of the text in which characters are removed from comprehension and at least one subsequent modification in which removed characters re-appear for comprehension; and the characters being removed in each step by overlay of one or more masks.

Statement thirty: The method of statement twenty nine in which the characters are removed and re-appear in groups forming words.

Statement thirty one: A method of presenting text to a subject, the method comprising the steps of: presenting text on a computer display in human comprehensible format, where the text includes characters; in a succession of steps, presenting a series of modifications of the text in human comprehensible format, the series of modifications incorporating at least a first modification of the text in which characters are removed from comprehension and at least one subsequent modification in which removed characters re-appear for comprehension; and between steps in the succession of steps, prompting the user to input missing text in order to progress to the next step.

Statement thirty two: A method of presenting text to a subject, the method comprising the steps of: presenting text on a computer display in human comprehensible format, where the text includes characters; in a succession of steps, presenting a series of modifications of the text in human comprehensible format, the series of modifications incorporating at least a first modification of the text in which characters are removed from comprehension and at least one subsequent modification in which removed characters re-appear for comprehension; and making removed characters re-appear in response to an input from the subject.

Statement thirty three: The method of statement thirty two in which the characters are made to re-appear for comprehension temporarily.

Statement thirty four: The method of statement thirty two in which the characters are made to re-appear for comprehension temporarily for less than one second.

Statement thirty five: The method of statement thirty two in which the characters are made to re-appear for comprehension temporarily for less than two seconds.

Statement thirty six: A method of presenting text to a subject, the method comprising the steps of: presenting text in human comprehensible format, where the text includes characters; in a succession of steps, presenting a series of modifications of the text in human comprehensible format, the series of modifications incorporating at least a first modification of the text in which characters are removed from comprehension in a non-random pattern and at least one subsequent modification in which removed characters re-appear for comprehension; and the number of steps or type of modifications in the succession of steps are user selected.

Statement thirty seven: A method of presenting text to a subject, the method comprising the steps of: presenting text in audible human comprehensible format, where the text includes characters; and in a succession of steps, presenting a series of modifications of the text in human comprehensible format, the series of modifications incorporating at least a first modification of the text in which characters are removed from comprehension and at least one subsequent modification in which removed characters re-appear for comprehension.

Statement thirty eight: The method of statement thirty seven in which the characters are replaced and made to re-appear as audible words.

Statement thirty nine: The method of statement thirty seven in which, in the succession of steps, the majority of the text is audible initially and a majority of the text is inaudible subsequently.

Statement forty: The method of statement thirty seven in which removal from comprehension is carried out by replacing one or more characters with silence.

Statement forty one: The method of statement forty in which the length of the silence is indicative of the number of characters removed.

Statement forty two: The method of statement one in which the text is in a language that is foreign to the subject.

Statement forty three: The method of statement one in which the non-randomness of the pattern is determined by the types of the characters removed so that specific characters gain association with other types of characters.

Statement forty four: The method of statement one carried out using a computer, and the computer is responsive to input from the subject specifying characters the subject has difficulty with.

Statement forty five: The method of statement one in which only a first portion of the presented text is treated in a first series of steps.

Statement forty six: The method of statement forty five in which a second portion of the presented text is treated in a second series of steps.

Statement forty seven: The method of statement one used as a spelling tool.

Statement forty eight: The method of statement one used as a number memorization tool.

Statement forty nine: The method of statement one in which the text is presented, in each of the succession of steps, with characters appearing in same position.

Statement fifty: The method of statement one in which the text is presented, in each of the succession of steps, with constant character width.

Statement fifty one: The method of statement one in which the text is presented, in each of the succession of steps, with constant number of characters per line.

Statement fifty two: The method of statement twenty five in which the text is in a language that is foreign to the subject.

Statement fifty three: The method of statement twenty five in which the non-randomness of the pattern is determined by the types of the characters removed so that specific characters gain association with other types of characters.

Statement fifty four: The method of statement twenty five carried out using a computer, and the computer is responsive to input from the subject specifying characters the subject has difficulty with.

Statement fifty five: The method of statement twenty five in which only a first portion of the presented text is treated in a first series of steps.

Statement fifty six: The method of statement fifty five in which a second portion of the presented text is treated in a second series of steps.

Statement fifty seven: The method of statement twenty five used as a spelling tool.

Statement fifty eight: The method of statement twenty five used as a number memorization tool.

Statement fifty nine: The method of statement twenty five in which the text is presented, in each of the succession of steps, with characters appearing in same position.

Statement sixty: The method of statement twenty five in which the text is presented, in each of the succession of steps, with constant character width.

Statement sixty one: The method of statement twenty five in which the text is presented, in each of the succession of steps, with constant number of characters per line.

Statement sixty two: An audible memorization program such as for a computer whereby portions of text are replaced by silent or less distinguishable gaps in an ordered progression from the majority of the text being audible initially, to the majority of the text being non-audible subsequently, such that portions of text becomes audible again at least once after initially becoming non-audible.

Statement sixty three: A display of text to a viewer, the display comprising: a presentation of text in human comprehensible format, where the text includes characters; and a series of additional presentations of modifications of the text in human comprehensible format, the series of modifications incorporating at least a first modification of the text in which characters are removed from comprehension in a non-random pattern and at least one subsequent modification in which removed characters re-appear for comprehension.

Statement sixty four: The display of statement sixty three in which the presentations are made by a computer monitor.

Statement sixty five: The display of statement sixty three in which the text is printed text.

Statement sixty six: The display of statement sixty three further comprising a mask that is used to remove text from comprehension.

Statement sixty seven: The display of statement sixty six in which the text is printed text and the mask is a transparency.

Statement sixty eight: The display of statement sixty six in which the text is printed text and the mask is an LCD screen.

Statement sixty nine: A display of text to a viewer, the display comprising: a presentation of text in human comprehensible format, where the text includes characters; a series of additional presentations of modifications of the text in human comprehensible format, the series of modifications incorporating at least a first modification of the text in which characters are removed from comprehension in a non-random pattern and at least one subsequent modification in which removed characters re-appear for comprehension; and the series of modifications includes a specific modification in which every second word is removed to yield a set of alternating removed words and remaining words and a subsequent modification to the specific modification in which the removed words are made comprehensible again and the remaining words are removed from comprehension.

Statement seventy: The display of statement sixty nine in which the presentations are made by a computer monitor.

Statement seventy one: The display of statement sixty nine in which the text is printed text.

Statement seventy two: The display of statement sixty nine further comprising a mask that is used to remove text from comprehension.

Statement seventy three: The display of statement seventy two in which the text is printed text and the mask is a transparency.

Statement seventy four: The display of statement sixty nine in which the text is printed text and the mask is an LCD screen.

Statement seventy five: A display of text to a viewer, the display comprising: a presentation of text in human comprehensible format, where the text includes characters; a series of additional presentations of modifications of the text in human comprehensible format, the series of modifications incorporating at least a first modification of the text in which characters are removed from comprehension and at least one subsequent modification in which removed characters re-appear for comprehension; and the series of modifications of the text providing an association for a majority of the characters in the text.

Statement seventy six: The display of statement seventy five in which the presentations are made by a computer monitor.

Statement seventy seven: The display of statement seventy five in which the text is printed text.

Statement seventy eight: The display of statement seventy five further comprising a mask that is used to remove text from comprehension.

Statement seventy nine: The display of statement seventy eight in which the text is printed text and the mask is a transparency.

Statement eighty: The display of statement seventy eight in which the text is printed text and the mask is an LCD screen.

Statement eighty one: The method of statement seventy eight in which the characters are removed and re-appear in groups forming words.

Statement eighty two: Computer readable media containing instructions for carrying out the method steps of statement one.

Statement eighty three: Computer readable media containing instructions for carrying out the method steps of statement twenty five.

Statement eighty four: A text memorization or accelerated learning program such as for a computer display or printed text whereby words are removed in a progression of steps such that all the text is visible in the first step; every second word is visible in the second step; all the text is visible in the third step; and every second word is removed in the fourth step.

Statement eighty five: A memorization or accelerated learning program such as for a computer display or printed text whereby portions of text are removed in a progression of steps with the majority of the text being visible in a first step, and the majority of the text being removed in a last step, such that text becomes readable again after initially becoming non-readable.

1. A method of presenting text to a subject, the method comprising the steps of: presenting text in human comprehensible format, where the text includes words; in a succession of steps, presenting a series of modifications of the text in human comprehensible format, the series of modifications incorporating at least a first modification of the text in which words are removed from comprehension in a pattern and at least one subsequent modification in which removed words re-appear for comprehension; the series of modifications including: a modification of the text in which each fifth word, counting from a specific word, is removed; a modification of the text in which each fourth word, counting from the specific word, is removed; a modification of the text in which each third word, counting from the specific word, is removed; and a modification of the text in which each second word, counting from the specific word, is removed.

2. The method of claim 1 in which the specific word is the first word in the text.

3. The method of claim 1 in which the specific word is any word in the text.

4. The method of claim 1 in which the series of modifications is presented in the order specified in the claim.

5. The method of claim 1 in which the modifications in the series of modifications are presented sequentially, without intervening presentations.

6. The method of claim 1 in which the series of modifications further includes: a modification of the text in which only each second word, counting from the specific word, is present; a modification of the text in which only each third word, counting from the specific word, is present; a modification of the text in which only each fourth word, counting from the specific word, is present; a modification of the text in which only each fifth word, counting from the specific word, is present. and a modification of the text in which none of the words are present.

7. The method of claim 1 in which the text is presented visually.

8. A method of presenting text to a subject, the method comprising the steps of: presenting text in human comprehensible format, where the text includes words and in a succession of steps, presenting a series of modifications of the text in human comprehensible format, the series of modifications incorporating at least a first modification of the text in which words are removed from comprehension and at least one subsequent modification in which removed words re-appear for comprehension; and the series of modifications of the text providing an association for a majority of the words in the text.

9. The method of claim 8 in which the series of modifications of the text provides an association for all of the words in the text.

10. The method of claim 8 in which the presentation occurs over the internet, and removing words is carried out by deletion of words, obscuring of words or replacement of words by blanks or other marks.

11. The method of claim 8 in which removed words are replaced by a mark indicating the number of characters in the word.

12. The method of claim 8 in which words present in the first modification are spaced by not more than two words that are removed.

13. The method of claim 8 in which, where n words in a sequence are removed in a specific modification, no more than n+2 words are removed in the next succeeding modification.

14. A method of presenting to a subject, the method comprising the steps of: presenting text on a computer display in human comprehensible format, where the text includes words and in a succession of steps, presenting a series of modifications of the text in human comprehensible format, the series of modifications incorporating at least a first modification of the text in which words are removed from comprehension and at least one subsequent modification in which removed words re-appear for comprehension; and the series of modifications of the text providing an association for a majority of the words in the text.

15. The method of claim 8 in which the words are made to re-appear for comprehension temporarily for less than two seconds.

16. The method of claim 8 in which the text is in a language that is foreign to the subject.

17. The method of claim 8 in which types of the words are removed so that specific types of words gain association with other words.

18. The method of claim 8 carried out using a computer, and the computer is responsive to input from the subject specifying characters the subject has difficulty with.

19. The method of claim 8 used as a spelling tool where individual characters are removed and receive associations.

20. The method of claim or 8 used as a number memorization tool where individual characters are removed and receive associations.
